(19) United States
(12) Patent Application Publication
(10) Pub. No.: US 2010/0148617 A1
(43) Pub. Date: Jun. 17, 2010

(54) Asynchronous AC induction electrical machines in cross-interlockingly parallel connection

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/314,629

(22) Filed: Dec. 15, 2008

(51) Int. Cl. H02K 17/36

(52) U.S. Cl. 310/195

(57) ABSTRACT

At least two asynchronous AC induction electrical machines in parallel connection with the power source are respectively made with the main winding and control winding for operating the electrical machines, wherein the individually driven loading operations of the two electrical machines in cross-interlockingly parallel connection being parallel connected with the power source are led by the changes of individual electrical machine driving loading statuses to appear variable impedance operation so as to change the end voltage ratio between individual electrical machines in cross-interlockingly parallel connections.

### BACKGROUND OF THE INVENTION

(a) Field of the Invention

The present invention innovatively discloses that at least two asynchronous AC induction electrical machines (hereinafter referred to as electrical machine) in parallel connection with the power source are respectively installed with main winding and control winding for electrical machine operation, wherein the two electrical machines being combined by taking the example of cross-interlockingly parallel connection comprises the following:

The first electrical machine control winding and the first electrical machine main winding are windingly installed on the same polar axis or windingly installed at electrical angle between polar axes within the first electrical machine, wherein the two electrical machines are optionally operated in cross-interlockingly parallel connection according to operating requirements of the polarity relationship between the two to appear 1) additional exciting operation in the same polarities, or 2) differential exciting operation in reverse polarities;

The second electrical machine control winding and the second electrical machine main winding are windingly installed on the same polar axis or windingly installed at electrical angle between polar axes within the second electrical machine wherein the two electrical machines are optionally operated in cross-interlockingly parallel connection according to operating requirements of the polarity relationship between the two to appear 1) additional exciting operation in the same polarities, or 2) differential exciting operation in reverse polarities;

The first electrical machine main winding is the main operating winding of the first electrical machine, while the first terminal of the first electrical machine control winding is connected with the second terminal of the second electrical machine main winding installed in the second electrical machine;

The second electrical machine main winding is the main operating winding of the second electrical machine, wherein the first terminal of the second electrical machine control winding is connected with the second terminal of the first electrical machine main winding installed in the first electrical machine;

The first terminal of the first electrical machine main winding is connected with the first terminal of the second electrical machine main winding and further connected to the first terminal of the power source for input or output electric power;

The second terminal of the first electrical machine control winding are connected with the second terminal of the second electrical machine control winding and further connected to the second terminal of the power source for input or output electric power;

The windings of said first electrical machine and second electrical machine are parallel connected and are driven by the power source, wherein the operation effect of the first electrical machine and the second electrical machine being cross-interlockingly parallel connected to drive the load individually is led by the changes of individual electrical machine driving loading statuses to appear variable impedance operation so as to change the end voltage ratio between individual electrical machines in cross-interlockingly parallel connections thereby allowing each individual electrical machine to produce interaction of required electromagnetic effect.

(b) Description of the Prior Art

When multiple units of conventional asynchronous AC induction electrical machines being parallel connected for motor or generator function are individually operated to drive the load, the individual electrical machines operate independently, thereby unable to produce interaction of particular electromagnetic effect.

### SUMMARY OF THE INVENTION

The present invention innovatively discloses that at least two asynchronous AC induction electrical machines (hereinafter referred to as electrical machine) in parallel connection with the power source are respectively installed with main winding and control winding for electrical machine operation, take example for the two electrical machines in cross-interlockingly parallel connection, wherein the first electrical machine main winding is the main operating winding of the first electrical machine, while the first electrical machine control winding is series connected with the second electrical machine main winding of the second electrical machine, the first electrical machine control winding and the first electrical machine main winding are windingly installed on the same polar axis or windingly installed at electrical angle between polar axes within the first electrical machine, wherein the two electrical machines are optionally operated in cross-interlockingly parallel connection according to operating requirements of the polarity relationship between the two to appear 1) additional exciting operation in the same polarities, or 2) differential exciting operation in reverse polarities; the second electrical machine main winding being relatively installed within the second electrical machine is the main operating winding of the first electrical machine, while the second electrical machine control winding is series connected with the first electrical machine main winding of the first electrical machine, the second electrical machine control winding and the second electrical machine main winding are windingly installed on the same polar axis or windingly installed at electrical angle between polar axes within the second electrical machine wherein the two electrical machines are optionally operated in cross-interlockingly series connection according to operating requirements of the polarity relationship between the two to appear 1) additional exciting operation in the same polarities, or 2) differential exciting operation in reverse polarities, wherein the electrical machine in parallel connection with the power source being individually driven in loading operation causes the cross-interlockingly parallel connected electrical machine to appear variable impedance operation following variations of individual load-driven statuses of individual electrical machines thereby to let each individual electrical machine produce required interactive reactions by electrical machine effect.

In practical applications, the asynchronous AC induction electrical machines in cross-interlockingly parallel connection of present invention include the following:

The electrical specifications and characteristics of the main windings installed within respective individual asynchronous AC induction electrical machines can be the same or different;

The electrical specifications and characteristics of the control windings installed within respective individual asynchronous AC induction electrical machines can be the same or different;

The rated specifications and operating characteristics of respective individual asynchronous AC induction electrical machines can be the same or different;

The individual electrical machines can be constituted by asynchronous AC induction electrical machines having the same or different structural types and different operating characteristics;

For the asynchronous AC induction electrical machines in cross-interlockingly parallel connection of present invention, the individual electrical machines being mutually parallel connected are directly driven by AC electric power source, including AC single phase or multiple phase power sources, or DC to AC power source, wherein the power source can be fixed or modulated by voltage, frequency, or frequency and voltage together for rotational speed, rotating torque, rotational direction, or power regeneration braking operations, or used as the coupling transmission device under asynchronous electromagnetic effect for transmission operation.

### BRIEF DESCRIPTION OF THE DRAWINGS

FIG. 1 is a structural schematic view of asynchronous AC induction electrical machines in cross-interlockingly parallel connection of the present invention comprising two asynchronous AC induction electrical machines in series connection.

FIG. 2 is a schematic view of the embodiment of the present invention showing that two Y connected 3-phase asynchronous AC induction electrical machines are in cross-interlockingly parallel connection to be driven by the 3-phase AC power source.

FIG. 3 is a schematic view of the embodiment of the present invention showing that two 3-phase 4-wire Y connected 3-phase asynchronous AC induction electrical machines are in cross-interlockingly parallel connection to be driven by the 3-phase 4-wire power source.

FIG. 4 is a schematic view of the embodiment of the present invention showing that two □ connected 3-phase asynchronous AC induction electrical machines are in cross-interlockingly parallel connection to being driven by the 3-phase AC power source.

FIG. 5 is a structural schematic view of the asynchronous AC induction electrical machines in cross-interlockingly parallel connection of the present invention comprising three asynchronous AC induction electrical machines in parallel connection.

### DESCRIPTION OF MAIN COMPONENT SYMBOLS

100: First electrical machine
101: First electrical machine main winding
102: First electrical machine control winding
200: Second electrical machine
201: Second electrical machine main winding
202: Second electrical machine control winding
300: Third electrical machine
301: Third electrical machine main winding
302: Third electrical machine control winding
1000: Power source
3100: First 3-phase electrical machine
3101: First 3-phase electrical machine main winding
3102: First 3-phase electrical machine control winding
3200: Second 3-phase electrical machine
3201: Second 3-phase electrical machine main winding
3202: Second 3-phase electrical machine control winding

### DETAILED DESCRIPTION OF THE PREFERRED EMBODIMENTS

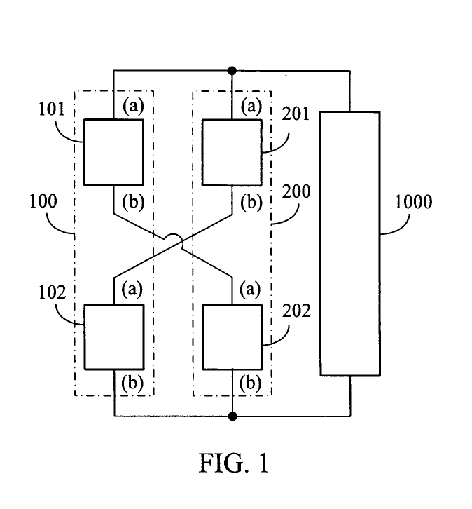

The principle of the present invention is delineated in the following: FIG. 1 is a structural schematic view of asynchronous AC induction electrical machines in cross-interlockingly parallel connection of the present invention comprising two asynchronous AC induction electrical machines in parallel connection.

As shown in FIG. 1, the cross-interlocked parallel connected circuit is driven by power source (1000) which includes AC single phase or multiple phase power sources, or DC to AC power source; the power source can be fixed or modulated by voltage, frequency, or frequency and voltage together.

The present invention innovatively discloses that at least two asynchronous AC induction electrical machines (hereinafter referred to as electrical machine) in parallel connection with the power source are respectively installed with main winding and control winding for electrical machine operation, wherein the two electrical machines in cross-interlockingly parallel connection is taken as the example to constitute the following:

The first electrical machine main winding (1101) is the main operating winding of the first electrical machine (100), while terminal (a) of the first electrical machine control winding (102) is series connected with terminal (b) of the second electrical machine main winding (201) of the second electrical machine (200), the first electrical machine control winding (102) and the first electrical machine main winding (101) are windingly installed on the same polar axis or windingly installed at electrical angle between polar axes within the first electrical machine (100), wherein the two electrical machines (100, 200) are optionally operated in cross-interlockingly parallel connection according to operating requirements of the polarity relationship between the two to appear 1) additional exciting operation in the same polarities, or 2) differential exciting operation in reverse polarities;

The second electrical machine main winding (201) being installed within the second electrical machine (200) is the main operating winding of the second electrical machine (200), while terminal (a) of the second electrical machine control winding (202) is series connected with terminal (b) of the first electrical machine main winding (101) of the first electrical machine (100), the second electrical machine control winding (202) and the second electrical machine main winding (101) are windingly installed on the same polar axis or windingly installed at electrical angle between polar axes within the second electrical machine (200) wherein the two electrical machines are optionally operated in cross-interlockingly parallel connection according to operating requirements of the polarity relationship between the two to appear 1) additional exciting operation in the same polarities, or 2) differential exciting operation in reverse polarities;

The terminal (a) of the first electrical machine main winding (101) of the first electrical machine (100) and the terminal (a) of the second electrical machine main winding (201) of the second electrical machine (200) are connected to one terminal of the power source (1000); the terminal (b) of the first electrical machine control winding (102) of the first electrical machine (100) is connected with terminal (b) of the second electrical machine control winding (202) of the second electrical machine (200) to further connect to the other terminal of the power source (1000), wherein the two electrical machines (100, 200) in cross-interlockingly parallel connection being parallel connected with the power source (1000) during the operation of individually driven loadings appear variable impedance operation following variations of individual load-driven statuses of individual electrical machines thereby to let each relatively mutually interlockingly parallel connected individual electrical machine produce the required interactive reactions by electrical machine effect.

In electricity discharge operation, if the current is changed due to loading variation of the first electrical machine (100), then exciting current of the second electrical machine control winding (202) of the second electrical machine (200) being series connected with the first electrical machine main winding (101) is simultaneously varied, so that the synthetic magnetic flux between the second electrical machine main winding (201) and the second electrical machine control winding (202) is varied according to polarity relationship, positional relationship of polar axis electrical angle, and phase relationship of exciting current between the two thereby allowing the torque and rotational speed of the second electrical machine (200) to be adjusted following the changes of its own end voltage and loading as well as the changes of operating current at the first electrical machine main winding (101) of the first electrical machine (100) being series connected with the second electrical machine control winding (202) simultaneously; on the contrary, if the current is changed due to loading variation of the second electrical machine (200), then exciting current of the first electrical machine control winding (102) of the first electrical machine (100) being series connected with the second electrical machine main winding (201) is simultaneously varied, so that the synthetic magnetic flux between the first electrical machine main winding (101) and the first electrical machine control winding (102) is varied according to polarity relationship, positional relationship of polar axis electrical angle, and phase relationship of exciting current between the two thereby allowing the torque and rotational speed of the first electrical machine (100) to be adjusted following changes of its own loading and changes of operating current at the second electrical machine main winding (201) of the second electrical machine (200) being series connected with the first electrical machine control winding (102) simultaneously.

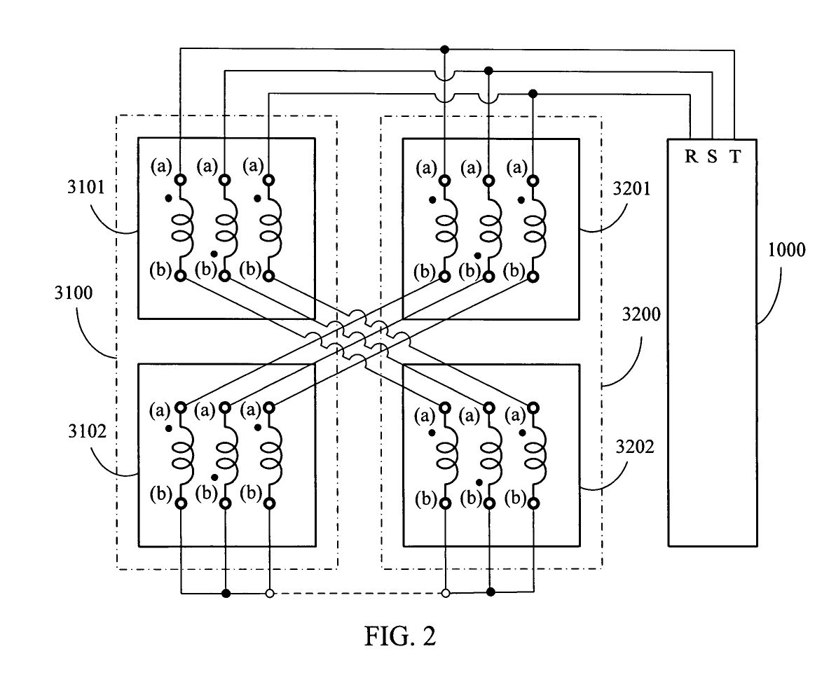

FIG. 2 is a schematic view of the embodiment of the present invention showing that two Y connected 3-phase asynchronous AC induction electrical machines are in cross-interlockingly parallel connection to be driven by the 3-phase AC power source;

Wherein:

The first 3-phase electrical machine control winding (3102) and the first 3-phase electrical machine main winding (3101) are windingly installed on the same polar axis or windingly installed at electrical angle between polar axes within the first 3-phase electrical machine (3100), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;

The second 3-phase electrical machine control winding (3202) and the second 3-phase electrical machine main winding (3201) are windingly installed on the same polar axis or windingly installed at electrical angle between polar axes within the second 3-phase electrical machine (3200), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;

The first 3-phase electrical machine main winding (3101) is the main operating winding of the first 3-phase electrical machine (3100), wherein terminal (a) of each phase winding of the first 3-phase electrical machine control winding (3102) is connected with terminal (b) of each phase winding of the second 3-phase electrical machine main winding (3201) being installed within the second 3-phase electrical machine (3200);

The second 3-phase electrical machine main winding (3201) is the main operating winding of the second 3-phase electrical machine (3200), wherein terminal (a) of each phase winding of the second 3-phase electrical machine control winding (3202) is connected with terminal (b) of each phase winding of the first 3-phase electrical machine main winding (3101) being installed within the first 3-phase electrical machine (3100);

The terminal (a) of each phase winding of the first 3-phase electrical machine main winding (3101) and the terminal (a) of each phase winding of the second 3-phase electrical machine main winding (3201) are connected to terminals R.S.T. of the 3-phase power source;

The terminal (b) of each phase winding of the first 3-phase electrical machine control winding (3102) is commonly in Y connection, and the terminal (b) of each phase winding of the second 3-phase electrical machine control winding (3202) is commonly in Y connection, wherein the common Y connecting point of the two electrical machines (3100, 3200) can be separated, or the common Y connecting point of the two electrical machines (3100, 3200) can be connected;

Said first 3-phase electrical machine (3100) and said second 3-phase electrical machine (3200) are connected to the AC 3-phase power source (1000), wherein the first 3-phase electrical machine (3100) and the second 3-phase electrical machine (3200) in the operation of individually driven loadings are by the effect of cross-interlockingly parallel connected operation to appear variable impedance operation according to the changes of individual electrical machine driving loading statuses so as to change the end voltage ratio between individual electrical machines in cross-interlockingly parallel connections thereby allowing each individual electrical machine to produce interaction of required electromagnetic effect.

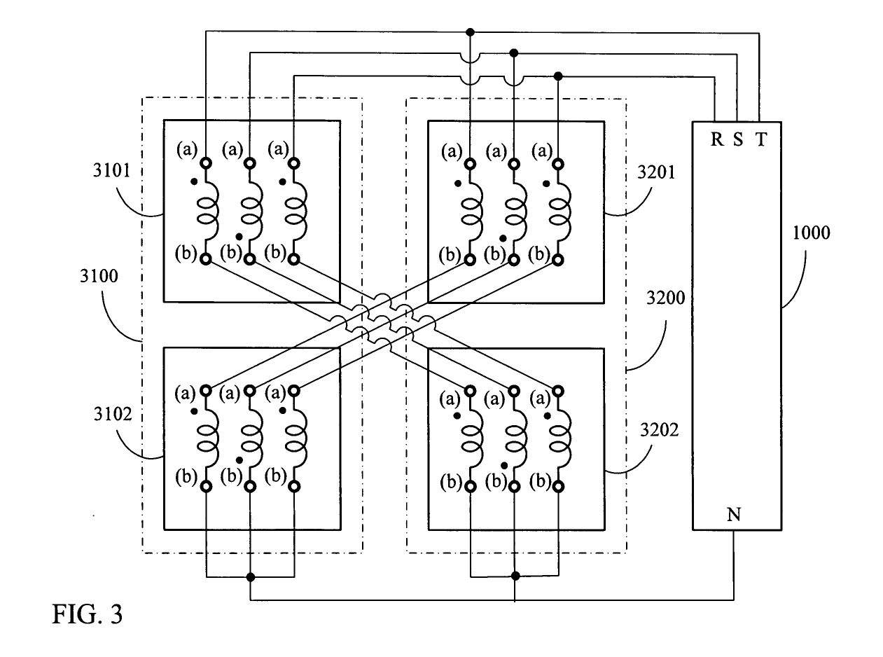

FIG. 3 is a schematic view of the embodiment of the present invention showing that two 3-phase 4-wire Y connected 3-phase asynchronous AC induction electrical machines are in cross-interlockingly parallel connection to be driven by the 3-phase 4-wire power source;

wherein:

The first 3-phase electrical machine control winding (3102) and the first 3-phase electrical machine main winding (3101) are windingly installed on the same polar axis or windingly installed at electrical angle between polar axes within the first 3-phase electrical machine (3100), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;

The second 3-phase electrical machine control winding (3202) and the second 3-phase electrical machine main winding (3201) are windingly installed on the same polar axis or windingly installed at electrical angle between polar axes within the second 3-phase electrical machine (3200), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;

The first 3-phase electrical machine main winding (3101) is the main operating winding of the first 3-phase electrical machine (3100), wherein terminal (a) of each phase winding of the first 3-phase electrical machine control winding (3102) is connected with terminal (b) of each phase winding of the second 3-phase electrical machine main winding (3201) being installed within the second 3-phase electrical machine (3200);

The second 3-phase electrical machine main winding (3201) is the main operating winding of the second 3-phase electrical machine (3200), wherein terminal (a) of each phase winding of the second 3-phase electrical machine control winding (3202) is connected with terminal (b) of each phase winding of the first 3-phase electrical machine main winding (3101) being installed within the first 3-phase electrical machine (3100);

The terminal (a) of each phase winding of the first 3-phase electrical machine main winding (3101) and the terminal (a) of each phase winding of the second 3-phase electrical machine main winding (3201) are commonly connected to terminals R.S.T. of the AC 3-phase 4-wire power source (1000);

The terminal (b) of each phase winding of the first 3-phase electrical machine control winding (3102) is commonly connected and the terminal (b) of each phase winding of the second 3-phase electrical machine control winding (3202) is commonly in Y connection, wherein the common Y connecting point of the two electrical machines is connected to the neutral terminal N of the AC 3-phase 4-wire power source;

Said first 3-phase electrical machine (3100) and said second 3-phase electrical machine (3200) are driven by the AC 3-phase 4-wire power source (1000), wherein the first 3-phase electrical machine (3100) and the second 3-phase electrical machine (3200) in the operation of individually driven loadings are by the effect of cross-interlockingly parallel connected operation to appear variable impedance operation according to the changes of individual electrical machine driving loading statuses so as to change the end voltage ratio between individual electrical machines in cross-interlockingly parallel connections thereby allowing each individual electrical machine to produce interaction of required electromagnetic effect.

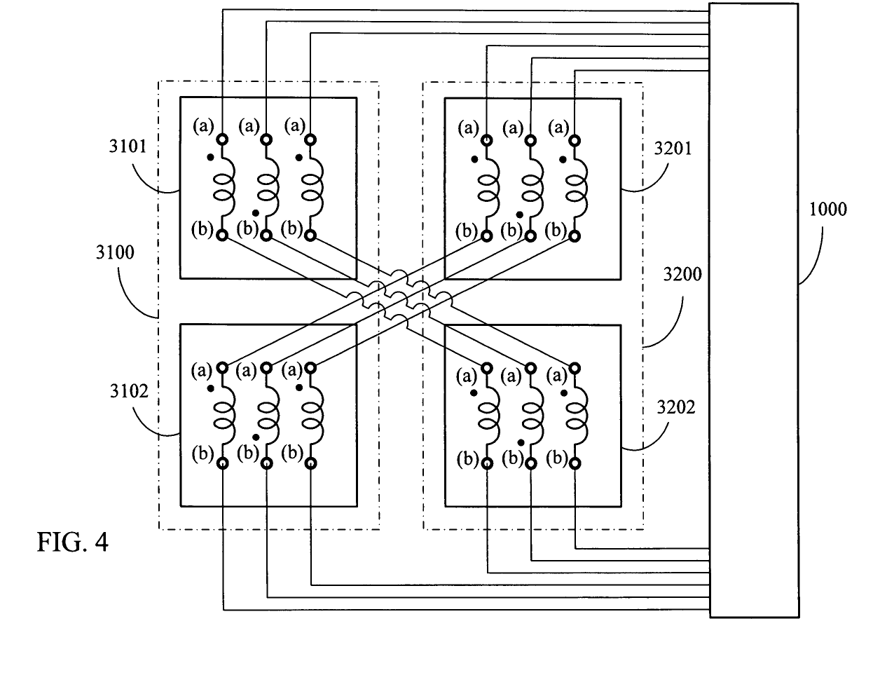

FIG. 4 is a schematic view of the embodiment of the present invention showing that two □ connected 3-phase asynchronous AC induction electrical machines are in cross-interlockingly parallel connection to being driven by the 3-phase AC power source;

wherein:

The first 3-phase electrical machine control winding (3102) and the first 3-phase electrical machine main winding (3101) are windingly installed on the same polar axis or windingly installed at electrical angle between polar axes within the first 3-phase electrical machine (3100), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;

The second 3-phase electrical machine control winding (3202) and the second 3-phase electrical machine main winding (3201) are windingly installed on the same polar axis or windingly installed at electrical angle between polar axes within the second 3-phase electrical machine (3200), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;

The first 3-phase electrical machine main winding (3101) is the main operating winding of the first 3-phase electrical machine (3100), wherein the first terminal of the first 3-phase electrical machine control winding (3102) is connected with the second terminal of the second 3-phase electrical machine main winding (3201) being installed within the second 3-phase electrical machine (3200);

The second 3-phase electrical machine main winding (3201) is the main operating winding of the second 3-phase electrical machine (3200), wherein terminal (a) of each phase winding of the second 3-phase electrical machine control winding (3202) is connected with terminal (b) of each phase winding of the first 3-phase electrical machine main winding (3101) being installed within the first 3-phase electrical machine (3100);

The connecting methods of 3-phase □ connection can be following:

The terminal (a) of each phase winding of the first 3-phase electrical machine main winding (3101) and terminal (b) of each phase winding of the first 3-phase electrical machine control winding (3102) are in 3-phase □ connection and further connected to the AC 3-phase power source (1000);

The terminal (a) of each phase winding of the second 3-phase electrical machine main winding (3201) and terminal (b) of each phase winding of the first 3-phase electrical machine control winding (3102) are in 3-phase Δ connection and further connected to the AC 3-phase power source (1000);

The connecting methods of 3-phase □ connection can also be following:

The terminal (a) of each phase winding of the first 3-phase electrical machine main winding (3101) and terminal (b) of each phase winding of the first 3-phase electrical machine control winding (3102) are in 3-phase □ connection and further connected to the AC 3-phase power source (1000);

The terminal (a) of each phase winding of the second 3-phase electrical machine main winding (3201) and terminal (b) of each phase winding of the second 3-phase electrical machine control winding (3202) are in 3-phase Δ connection and further connected to the AC 3-phase power source (1000);

Said first 3-phase electrical machine (3100) and said second 3-phase electrical machine (3200) are connected to the AC 3-phase power source (1000), wherein the first 3-phase electrical machine (3100) and the second 3-phase electrical machine (3200) in the operation of individually driven loadings are by the effect of cross-interlockingly parallel connected operation to appear variable impedance operation according to the changes of individual electrical machine driving loading statuses so as to change the end voltage ratio between individual electrical machines in cross-interlockingly parallel connections thereby allowing each individual electrical machine to produce interaction of required electromagnetic effect.

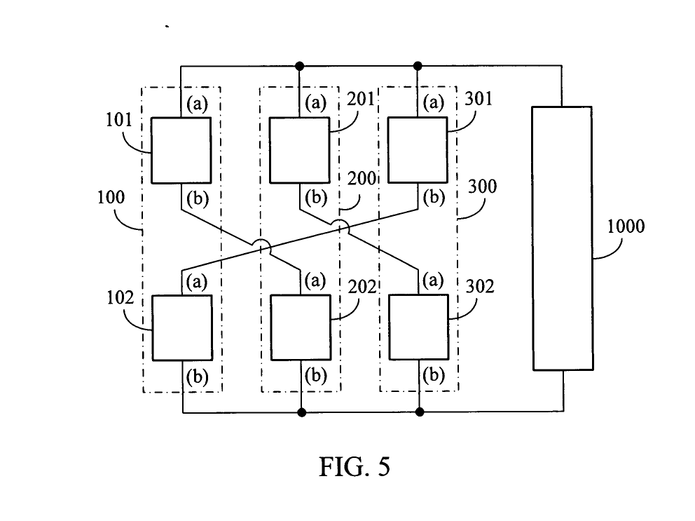

The aforesaid principles can also be applied to multiple electrical machines, such as that FIG. 5 is a structural schematic view of the asynchronous AC induction electrical machines in cross-interlockingly parallel connection of the present invention comprising three asynchronous AC induction electrical machines in parallel connection; as shown in FIG. 5:

The magnetic field of the first electrical machine (100) is windingly installed with the first electrical machine main winding (101) and windingly installed with the first electrical machine control winding (102) on the same polar axis or at electrical angle between polar axes, wherein terminal (a) of the first electrical machine control winding (102) is series connected with terminal (b) of the third electrical machine main winding (301) being windingly installed within the third electrical machine (300); the magnetic field of the second electrical machine (200) is windingly installed with the second electrical machine main winding (201) and windingly installed with the second electrical machine control winding (202) on the same polar axis or at electrical angle between polar axes, wherein terminal (a) of the second electrical machine control winding (202) is series connected with terminal (b) of the first electrical machine main winding (101) being windingly installed within the first electrical machine (100); the magnetic field of the third electrical machine (300) is windingly installed with the third electrical machine main winding (301) and windingly installed with the third electrical machine control winding (302) on the same polar axis or at electrical angle between polar axes, wherein terminal (a) of the third electrical machine control winding (302) is series connected with terminal (b) of the second electrical machine main winding (201) being windingly installed within the second electrical machine (200);

The terminal (a) of the first electrical machine main winding (101) of the first electrical machine (100) and terminal (a) of the second electrical machine main winding (201) of the second electrical machine (200) are connected with the terminal (a) of the third electrical machine main winding (301) of the third electrical machine (300) and further connected to one terminal of the power source (1000); the terminal (b) of the first electrical machine control winding (102) of the first electrical machine (100) and terminal (b) of the second electrical machine control winding (202) of the second electrical machine (200) are connected with the terminal (b) of the third electrical machine control winding (302) of the third electrical machine (300) and further connected to the other terminal of the power source (1000), it is through the combining status of the particular parallel connections between main windings and control windings of aforesaid three electrical machines being individually powered by the power source (1000) to drive loads and following variations of individual load-driven statuses of individual electrical machines to allow individual electrical machines to produce required interactive reactions by the electrical machine effect.

For the asynchronous AC induction electrical machines in cross-interlockingly parallel connection of present invention, if the number of constituting electrical machines is increased, the aforesaid principles and theories can be similarly deducted.

For the asynchronous AC induction electrical machines in cross-interlockingly parallel connection of present invention, the defined asynchronous AC electrical machine is constituted by rotating magnetic field and the asynchronously actuated interactive body induced by electromagnetic effect.

In practical application, the asynchronous AC induction electrical machines in cross-interlockingly parallel connection of present invention can be constituted by multiple units of one type or mixed types of squirrel cage type electrical machines or eddy current induction type asynchronous AC electrical machines to include the following combinations according to functional requirements: it is applied 1) for asynchronous AC induction squirrel cage type motor functional operations; or 2) for asynchronous eddy current induction motor functional operations; or 3) for asynchronous AC induction squirrel cage type generator functional operations; or 4) for asynchronous eddy current induction generator functional operations; or 5) for partial generator functional operation and partial motor functional operation; or 6) as the induction squirrel cage type electrical machine braking device; or 7) as the eddy current induction type electrical machine braking device; or 8) as the asynchronous induction squirrel type electromagnetic coupling transmission device; or 9) as the asynchronous eddy current induction type electromagnetic coupling transmission device.

For the asynchronous AC induction electrical machines in cross-interlockingly parallel connection of present invention, the excitation relationships between the main winding and the control winding in the electrical machine itself include the following:
(1) The main windings and control windings within all electrical machines themselves are installed in the same polarities; or
(2) The main windings and control windings within all electrical machines themselves are installed in reverse polarities; or
(3) The main windings and control windings within partial electrical machines themselves are installed in the same polarities, while the main windings and control windings within partial electrical machines themselves are installed in reverse polarities.

For the asynchronous AC induction electrical machines in cross-interlockingly parallel connection of present invention, the main winding and control winding within the individual electrical machine are installed on the same polarities or installed at electrical angle difference, wherein the method of installation at electrical angle difference is through control winding passing current to change distribution shape of the magnetic field constituted together with the main magnetic field.

For the asynchronous AC induction electrical machines in cross-interlockingly parallel connection of present invention, the individual electrical machines are mutually series connected and are directly driven by AC electric power source, including AC single phase or multi-phase power source, or DC to AC power source; wherein the power source is fixedly or voltage modulated, or is commonly modulated by frequency or voltage, or modulated by frequency and voltage simultaneously for rotational speed, rotating torque, rotational direction, or power regeneration braking operations, or used as the coupling transmission device under asynchronous electromagnetic effect for transmission operation.

1. The asynchronous AC induction electrical machines in cross-interlockingly parallel connection, which discloses that at least two asynchronous AC induction electrical machines (hereinafter referred to as electrical machine) in parallel connection with the power source are respectively installed with main winding and control winding for electrical machine operation, wherein the two electrical machines being combined by taking the example of cross-interlockingly parallel connection comprises the following:—The first electrical machine control winding and the first electrical machine main winding are windingly installed on the same polar axis or windingly installed at electrical angle between polar axes within the first electrical machine, wherein the two electrical machines are optionally operated in cross-interlockingly parallel connection according to operating requirements of the polarity relationship between the two to appear 1) additional exciting operation in the same polarities, or 2) differential exciting operation in reverse polarities;
The second electrical machine control winding and the second electrical machine main winding are windingly installed on the same polar axis or windingly installed at electrical angle between polar axes within the second electrical machine wherein the two electrical machines are optionally operated in cross-interlockingly parallel connection according to operating requirements of the polarity relationship between the two to appear 1) additional exciting operation in the same polarities, or 2) differential exciting operation in reverse polarities;
The first electrical machine main winding is the main operating winding of the first electrical machine, while the first terminal of the first electrical machine control winding is connected with the second terminal of the second electrical machine main winding installed in the second electrical machine;
The second electrical machine main winding is the main operating winding of the second electrical machine, wherein the first terminal of the second electrical machine control winding is connected with the second terminal of the first electrical machine main winding installed in the first electrical machine;
The first terminal of the first electrical machine main winding is connected with the first terminal of the second electrical machine main winding and further connected to the first terminal of the power source for input or output electric power;
The second terminal of the first electrical machine control winding are connected with the second terminal of the second electrical machine control winding and further connected to the second terminal of the power source for input or output electric power;
The windings of said first electrical machine and second electrical machine are parallel connected and are driven by the power source, wherein the operation effect of the first electrical machine and the second electrical machine being cross-interlockingly parallel connected to drive the load individually is led by the changes of individual electrical machine driving loading statuses to appear variable impedance operation so as to change the end voltage ratio between individual electrical machines in cross-interlockingly parallel connections thereby allowing each individual electrical machine to produce interaction of required electromagnetic effect.

2. The asynchronous AC induction electrical machines in cross-interlockingly parallel connection as claimed in claim 1, wherein the electrical specifications and characteristics of the main windings installed within respective individual asynchronous AC induction electrical machines can be the same or different.

3. The asynchronous AC induction electrical machines in cross-interlockingly parallel connection as claimed in claim 1, wherein the electrical specifications and characteristics of the control windings installed within respective individual asynchronous AC induction electrical machines can be the same or different.

4. The asynchronous AC induction electrical machines in cross-interlockingly parallel connection as claimed in claim 1, wherein the rated specifications and operating characteristics of respective individual asynchronous AC induction electrical machines can be the same or different.

5. The asynchronous AC induction electrical machines in cross-interlockingly parallel connection as claimed in claim 1, wherein the individual electrical machines can be constituted by asynchronous AC induction electrical machines having the same or different structural types and different operating characteristics.

6. The asynchronous AC induction electrical machines in cross-interlockingly parallel connection as claimed in claim 1, wherein it is driven by AC electric power source, including AC single phase or multiple phase power sources, or DC to AC power source, wherein the power source can be fixed or modulated by voltage, frequency, or frequency and voltage together for rotational speed, rotating torque, rotational direction, or power regeneration braking operations, or used as the coupling transmission device under asynchronous electromagnetic effect for transmission operation.

7. The asynchronous AC induction electrical machines in cross-interlockingly parallel connection as claimed in claim 1, wherein it includes adopting two electrical machines in cross-interlockingly parallel connection to constitute the following:
The first electrical machine main winding (101) is the main operating winding of the first electrical machine (100), while terminal (a) of the first electrical machine control winding (102) is series connected with terminal (b) of the second electrical machine main winding (201) of the second electrical machine (200), the first electrical machine control winding (102) and the first electrical machine main winding (101) are windingly installed on the same polar axis or windingly installed at electrical angle between polar axes within the first electrical machine (100), wherein the two electrical machines (100, 200) are optionally operated in cross-interlockingly parallel connection according to operating requirements of the polarity relationship between the two to appear 1) additional exciting operation in the same polarities, or 2) differential exciting operation in reverse polarities;
The second electrical machine main winding (201) being installed within the second electrical machine (200) is the main operating winding of the second electrical machine (200), while terminal (a) of the second electrical machine control winding (202) is series connected with terminal (b) of the first electrical machine main winding (101) of the first electrical machine (100), the second electrical machine control winding (202) and the second electrical machine main winding (101) are windingly installed on the same polar axis or windingly installed at electrical angle between polar axes within the second electrical machine (200) wherein the two electrical machines are optionally operated in cross-interlockingly parallel connection according to operating requirements of the polarity relationship between the two to appear 1) additional exciting operation in the same polarities, or 2) differential exciting operation in reverse polarities;
The terminal (a) of the first electrical machine main winding (101) of the first electrical machine (100) and the terminal (a) of second electrical machine main winding (201) of the second electrical machine (200) are connected to one terminal of the power source (1000); the terminal (b) of the first electrical machine control winding (102) of the first electrical machine (100) is connected with terminal (b) of the second electrical machine control winding (202) of the second electrical machine to further connect to the other terminal of the power source (1000), wherein the two electrical machines (100, 200) in cross-interlockingly parallel connection being parallel connected with the power source (1000) during the operation of individually driven loadings appear variable impedance operation following variations of individual load-driven statuses of individual electrical machines thereby to let each relatively mutually interlockingly parallel connected individual electrical machine produce the required interactive reactions by electrical machine effect;
In electricity discharge operation, if the current is changed due to loading variation of the first electrical machine (100), then exciting current of the second electrical machine control winding (202) of the second electrical machine (200) being series connected with the first electrical machine main winding (101) is simultaneously varied, so that the synthetic magnetic flux between the second electrical machine main winding (201) and the second electrical machine control winding (202) is varied according to polarity relationship, positional relationship of polar axis electrical angle, and phase relationship of exciting current between the two thereby allowing the torque and rotational speed of the second electrical machine (200) to be adjusted following the changes of its own end voltage and loading as well as the changes of operating current at the first electrical machine main winding (101) of the first electrical machine (100) being series connected with the second electrical machine control winding (202) simultaneously; on the contrary, if the current is changed due to loading variation of the second electrical machine (200), then exciting current of the first electrical machine control winding (102) of the first electrical machine (100) being series connected with the second electrical machine main winding (201) is simultaneously varied, so that the synthetic magnetic flux between the first electrical machine main winding (101) and the first electrical machine control winding (102) is varied according to polarity relationship, positional relationship of polar axis electrical angle, and phase relationship of exciting current between the two thereby allowing the torque and rotational speed of the first electrical machine (100) to be adjusted following changes of its own loading and changes of operating current at the second electrical machine main winding (201) of the second electrical machine (200) being series connected with the first electrical machine control winding (102) simultaneously.

8. The asynchronous AC induction electrical machines in cross-interlockingly parallel connection as claimed in claim 1, wherein it includes adopting two Y connected 3-phase asynchronous AC induction electrical machines to be driven by 3-phase AC power source, wherein:
The first 3-phase electrical machine control winding (3102) and the first 3-phase electrical machine main winding (3101) are windingly installed on the same polar axis or windingly installed at electrical angle between polar axes within the first 3-phase electrical machine (3100), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;
The second 3-phase electrical machine control winding (3202) and the second 3-phase electrical machine main winding (3201) are windingly installed on the same polar axis or windingly installed at electrical angle between polar axes within the second 3-phase electrical machine (3200), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;
The first 3-phase electrical machine main winding (3101) is the main operating winding of the first 3-phase electrical machine (3100), wherein terminal (a) of each phase winding of the first 3-phase electrical machine control winding (3102) is connected with terminal (b) of each phase winding of the second 3-phase electrical machine main winding (3201) being installed within the second 3-phase electrical machine (3200);
The second 3-phase electrical machine main winding (3201) is the main operating winding of the second 3-phase electrical machine (3200), wherein terminal (a) of each phase winding of the second 3-phase electrical machine control winding (3202) is connected with terminal (b) of each phase winding of the first 3-phase electrical machine main winding (3101) being installed within the first 3-phase electrical machine (3100);
The terminal (a) of each phase winding of the first 3-phase electrical machine main winding (3101) and the terminal (a) of each phase winding of the second 3-phase electrical machine main winding (3201) are connected to terminals R.S.T. of the 3-phase power source;
The terminal (b) of each phase winding of the first 3-phase electrical machine control winding (3102) is commonly in Y connection, and the terminal (b) of each phase winding of the second 3-phase electrical machine control winding (3202) is commonly in Y connection, wherein the common Y connecting point of the two electrical machines (3100, 3200) can be separated, or the common Y connecting point of the two electrical machines (3100, 3200) can be connected;
Said first 3-phase electrical machine (3100) and said second 3-phase electrical machine (3200) are connected to the AC 3-phase power source (1000), wherein the first 3-phase electrical machine (3100) and the second 3-phase electrical machine (3200) in the operation of individually driven loadings are by the effect of cross-interlockingly parallel connected operation to appear variable impedance operation according to the changes of individual electrical machine driving loading statuses so as to change the end voltage ratio between individual electrical machines in cross-interlockingly parallel connections thereby allowing each individual electrical machine to produce interaction of required electromagnetic effect.

9. The asynchronous AC induction electrical machines in cross-interlockingly parallel connection as claimed in claim 1, wherein it includes adopting two 3-phase 4-wire Y connected 3-phase asynchronous AC induction electrical machines to be driven by the 3-phase 4-wire power source, wherein:
The first 3-phase electrical machine control winding (3102) and the first 3-phase electrical machine main winding (3101) are windingly installed on the same polar axis or windingly installed at electrical angle between polar axes within the first 3-phase electrical machine (3100), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;
The second 3-phase electrical machine control winding (3202) and the second 3-phase electrical machine main winding (3201) are windingly installed on the same polar axis or windingly installed at electrical angle between polar axes within the second 3-phase electrical machine (3200), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;
The first 3-phase electrical machine main winding (3101) is the main operating winding of the first 3-phase electrical machine (3100), wherein terminal (a) of each phase winding of the first 3-phase electrical machine control winding (3102) is connected with terminal (b) of each phase winding of the second 3-phase electrical machine main winding (3201) being installed within the second 3-phase electrical machine (3200);
The second 3-phase electrical machine main winding (3201) is the main operating winding of the second 3-phase electrical machine (3200), wherein terminal (a) of each phase winding of the second 3-phase electrical machine control winding (3202) is connected with terminal (b) of each phase winding of the first 3-phase electrical machine main winding (3101) being installed within the first 3-phase electrical machine (3100);
The terminal (a) of each phase winding of the first 3-phase electrical machine main winding (3101) and the terminal (a) of each phase winding of the second 3-phase electrical machine main winding (3201) are commonly connected to terminals R.S.T. of the AC 3-phase 4-wire power source (1000);
The terminal (b) of each phase winding of the first 3-phase electrical machine control winding (3102) is commonly connected and the terminal (b) of each phase winding of the second 3-phase electrical machine control winding (3202) is commonly in Y connection, wherein the common Y connecting point of the two electrical machines is connected to the neutral terminal N of the AC 3-phase 4-wire power source;
Said first 3-phase electrical machine (3100) and said second 3-phase electrical machine (3200) are driven by the AC 3-phase 4-wire power source (1000), wherein the first 3-phase electrical machine (3100) and the second 3-phase electrical machine (3200) in the operation of individually driven loadings are by the effect of cross-interlockingly parallel connected operation to appear variable impedance operation according to the changes of individual electrical machine driving loading statuses so as to change the end voltage ratio between individual electrical machines in cross-interlockingly parallel connections thereby allowing each individual electrical machine to produce interaction of required electromagnetic effect.

10. The asynchronous AC induction electrical machines in cross-interlockingly parallel connection as claimed in claim 1, wherein it includes adopting two □ connected 3-phase asynchronous AC induction electrical machines to be driven by the 3-phase AC power source, wherein:
The first 3-phase electrical machine control winding (3102) and the first 3-phase electrical machine main winding (3101) are windingly installed on the same polar axis or windingly installed at electrical angle between polar axes within the first 3-phase electrical machine (3100), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;
The second 3-phase electrical machine control winding (3202) and the second 3-phase electrical machine main winding (3201) are windingly installed on the same polar axis or windingly installed at electrical angle between polar axes within the second 3-phase electrical machine (3200), wherein the two electrical machines (3100, 3200) are optionally operated in cross-interlockingly parallel connection according to operating requirements of the polarity relationship between the two to appear 1) additional exciting operation in the same polarities, or 2) differential exciting operation in reverse polarities;
The first 3-phase electrical machine main winding (3101) is the main operating winding of the first 3-phase electrical machine (3100), wherein the first terminal of the first 3-phase electrical machine control winding (3102) is connected with the second terminal of the second 3-phase electrical machine main winding (3201) being installed within the second 3-phase electrical machine (3200);
The second 3-phase electrical machine main winding (3201) is the main operating winding of the second 3-phase electrical machine (3200), wherein terminal (a) of each phase winding of the second 3-phase electrical machine control winding (3202) is connected with terminal (b) of each phase winding of the first 3-phase electrical machine main winding (3101) being installed within the first 3-phase electrical machine (3100);
The connecting methods of 3-phase □ connection can be following:
The terminal (a) of each phase winding of the first 3-phase electrical machine main winding (3101) and terminal (b) of each phase winding of the first 3-phase electrical machine control winding (3102) are in 3-phase □ connection and further connected to the AC 3-phase power source (1000);
The terminal (a) of each phase winding of the second 3-phase electrical machine main winding (3201) and terminal (b) of each phase winding of the first 3-phase electrical machine control winding (3102) are in 3-phase Δ connection and further connected to the AC 3-phase power source (1000);
The connecting methods of 3-phase □ connection can also be following:
The terminal (a) of each phase winding of the first 3-phase electrical machine main winding (3101) and terminal (b) of each phase winding of the first 3-phase electrical machine control winding (3102) are in 3-phase □ connection and further connected to the AC 3-phase power source (1000);
The terminal (a) of each phase winding of the second 3-phase electrical machine main winding (3201) and terminal (b) of each phase winding of the second 3-phase electrical machine control winding (3202) are in 3-phase Δ connection and further connected to the AC 3-phase power source (1000);
Said first 3-phase electrical machine (3100) and said second 3-phase electrical machine (3200) are connected to the AC 3-phase power source (1000), wherein the first 3-phase electrical machine (3100) and the second 3-phase electrical machine (3200) in the operation of individually driven loadings are by the effect of cross-interlockingly parallel connected operation to appear variable impedance operation according to the changes of individual electrical machine driving loading statuses so as to change the end voltage ratio between individual electrical machines in cross-interlockingly parallel connections thereby allowing each individual electrical machine to produce interaction of required electromagnetic effect.

11. The asynchronous AC induction electrical machines in cross-interlockingly parallel connection as claimed in claim 1, wherein it includes adopting three asynchronous AC induction electrical machines in parallel connection, wherein:
The magnetic field of the first electrical machine (100) is windingly installed with the first electrical machine main winding (101) and windingly installed with the first electrical machine control winding (102) on the same polar axis or at electrical angle between polar axes, wherein terminal (a) of the first electrical machine control winding (102) is series connected with terminal (b) of the third electrical machine main winding (301) being windingly installed within the third electrical machine (300); the magnetic field of the second electrical machine (200) is windingly installed with the second electrical machine main winding (201) and windingly installed with the second electrical machine control winding (202) on the same polar axis or at electrical angle between polar axes, wherein terminal (a) of the second electrical machine control winding (202) is series connected with terminal (b) of the first electrical machine main winding (101) being windingly installed within the first electrical machine (100); the magnetic field of the third electrical machine (300) is windingly installed with the third electrical machine main winding (301) and windingly installed with the third electrical machine control winding (302) on the same polar axis or at electrical angle between polar axes, wherein terminal (a) of the third electrical machine control winding (302) is series connected with terminal (b) of the second electrical machine main winding (201) being windingly installed within the second electrical machine (200);
The terminal (a) of the first electrical machine main winding (101) of the first electrical machine (100) and terminal (a) of the second electrical machine main winding (201) of the second electrical machine (200) are connected with the terminal (a) of the third electrical machine main winding (301) of the third electrical machine (300) and further connected to one terminal of the power source (1000); the terminal (b) of the first electrical machine control winding (102) of the first electrical machine (100) and terminal (b) of the second electrical machine control winding (202) of the second electrical machine (200) are connected with the terminal (b) of the third electrical machine control winding (302) of the third electrical machine (300) and further connected to the other terminal of the power source (1000), it is through the combining status of the particular parallel connections between main windings and control windings of aforesaid three electrical machines being individually powered by the power source (1000) to drive loads and following variations of individual load-driven statuses of individual electrical machines to allow individual electrical machines to produce required interactive reactions by the electrical machine effect;
For the asynchronous AC induction electrical machines in cross-interlockingly parallel connection of present invention, if the number of constituting electrical machines is increased, the aforesaid principles and theories can be similarly deducted.

12. The asynchronous AC induction electrical machines in cross-interlockingly parallel connection as claimed in claim 1, wherein the defined asynchronous AC electrical machine is constituted by rotating magnetic field and the asynchronously actuated interactive body induced by electromagnetic effect.

13. The asynchronous AC induction electrical machines in cross-interlockingly parallel connection as claimed in claim 1, wherein it includes to be applied 1) for asynchronous AC induction squirrel cage type motor functional operations; or 2) for asynchronous eddy current induction motor functional operations; or 3) for asynchronous AC induction squirrel cage type generator functional operations; or 4) for asynchronous eddy current induction generator functional operations; or 5) for partial generator functional operation and partial motor functional operation; or 6) as the induction squirrel cage type electrical machine braking device; or 7) as the eddy current induction type electrical machine braking device; or 8) as the asynchronous induction squirrel type electromagnetic coupling transmission device; or 9) as the asynchronous eddy current induction type electromagnetic coupling transmission device.

14. The asynchronous AC induction electrical machines in cross-interlockingly parallel connection as claimed in claim 1, wherein the excitation relationships between the main winding and the control winding in the electrical machine itself include the following:
1) The main windings and control windings within all electrical machines themselves are installed in the same polarities; or
2) The main windings and control windings within all electrical machines themselves are installed in reverse polarities; or
3) The main windings and control windings within partial electrical machines themselves are installed in the same polarities, while the main windings and control windings within partial electrical machines themselves are installed in reverse polarities.

15. The asynchronous AC induction electrical machines in cross-interlockingly parallel connection as claimed in claim 1, wherein the main winding and control winding within the individual electrical machine are installed on the same polarities or installed at electrical angle difference, wherein the method of installation at electrical angle difference is through control winding passing current to change distribution shape of the magnetic field constituted together with the main magnetic field.

16. The asynchronous AC induction electrical machines in cross-interlockingly parallel connection as claimed in claim 1, wherein the individual electrical machines are mutually series connected and are directly driven by AC electric power source, including AC single phase or multi-phase power source, or DC to AC power source; wherein the power source is fixedly or voltage modulated, or is commonly modulated by frequency or voltage, or modulated by frequency and voltage simultaneously for rotational speed, rotating torque, rotational direction, or power regeneration braking operations, or used as the coupling transmission device under asynchronous electromagnetic effect for transmission operation.
